(19) United States
(12) Patent Application Publication
(10) Pub. No.: US 2022/0230487 A1
(43) Pub. Date: Jul. 21, 2022

(54) METHODS OF STORING, ACCESSING, AND DISPLAYING VEHICLE-SPECIFIC SAFETY AND REPAIR INFORMATION

(71) Applicant: Scott Saal, Deer Park, NY (US)

(72) Inventor: Scott Saal, Deer Park, NY (US)

(21) Appl. No.: 17/537,628

(22) Filed: Nov. 30, 2021

Related U.S. Application Data
(60) Provisional application No. 63/137,844, filed on Jan. 15, 2021.

(51) Int. Cl. G07C 5/08; G06K 1/12; G06K 7/14; G06F 16/955

(52) U.S. Cl. CPC G07C 5/0816; G07C 5/0808; G06F 16/9554; G06K 7/1417; G06K 1/12

(57) ABSTRACT

A method of encoding and accessing information about an automobile includes marking a quick response code (“QR code”) into a glass surface of the automobile, scanning the barcode to access the information about the automobile, and displaying the information.

### CROSS-REFERENCE TO RELATED APPLICATION

This application claims the benefit of and priority to U.S. Provisional Patent Application No. 63/137,844, filed on Jan. 15, 2021, the entire contents of which are incorporated by reference herein.

### TECHNICAL FIELD

The present disclosure generally relates to methods of encoding, storing, and displaying safety and repair information about a vehicle on glass surfaces of the vehicle.

### BACKGROUND

Presently, to gain access to certain information about a particular vehicle one has limited options. In many instances, the particular information a person is looking for may be difficult to find in a driver's manual, is not found in the driver's manual, and/or the driver's manual is not present in the vehicle. If the information is not accessible or easily accessible within the vehicle, an owner, an auto-repair person, a collision repair technician, a potential purchaser, a tow company, a service provider, or the like, may alternatively try to consult the vehicle manufacturer's website. However, navigating the website may be difficult and/or the information desired may not be present. Further, the information may not be provided in a manner that is useful to the user or available when needed.

Accordingly, there is a need for an improved way to store, access, and display vehicle-safety and repair related specific information on the vehicle.

### SUMMARY

In one embodiment, in accordance with the principles of the present disclosure, a method of encoding, accessing, and displaying safety and repair information about an automobile (e.g., an electric vehicle) is provided. The method includes marking a barcode (e.g., a two-dimensional or three-dimensional barcode including a QR code, a data matrix code, a PDF417 code, or a snap tag) on or in a glass surface of the automobile. The barcode encodes, stores, or embeds information about the vehicle, such as, for example, the location of the battery or batteries, regular and maximum tire pressure, year, make, model, tow instructions, jacking instructions such as the locations on the chassis for positioning a car jack, paint codes, option codes, maintenance codes and other safety information. The method further includes scanning the barcode and displaying the information about the automobile.

In aspects, marking the barcode may include etching the barcode into the glass surface(s).

In aspects, the automobile may be an electric vehicle and the safety information about the electric vehicle may include jacking locations, towing instructions, or a location of a battery within the vehicle.

In aspects, the method may further include operating on the electric vehicle based on the jacking or battery locations or tow instructions to avoid jacking in an unsanctioned location or towing the vehicle improperly to avoid damage or injury.

In accordance with further aspects of the present disclosure, a method of encoding, accessing, and displaying information about an electric vehicle is provided that includes marking a quick response (QR) code into or onto a glass surface of the electric vehicle; accessing a mobile application on a mobile device; scanning the barcode with the mobile device; and displaying the information about the electric vehicle on the mobile application. The QR code encodes information about the electric vehicle, and the information includes jacking locations, jacking instructions, towing information, and/or a location of a battery.

In aspects, the method may further include operating on the electric vehicle based on the information about the electric vehicle.

In aspects, the method may include scanning the barcode and directing a user to a website or mobile application that has the information. The barcode may be scanned using a smart phone, a tablet, a hand-held scanner, or the like.

In aspects, the method may further include applying an opaque background on the glass surface prior to marking the QR code into or onto the glass surface.

In aspects, the user may first open the mobile application on their mobile device and scan one of the barcodes using their mobile device, which displays the vehicle-specific safety and repair data

In aspects, the barcode may be etched into one or more of the windshield (e.g., the bottom left or bottom right corner), the rear windshield, the side windows including passenger and driver side front and rear side windows and passenger and driver-side quarter glass windows, sliding door glass, rear hatch glass, rear stationary back window glass, etc.

### BRIEF DESCRIPTION OF THE DRAWINGS

The present disclosure will become more readily apparent from the specific description accompanied by the following drawings, in which:

FIG. 1 is a front, perspective view of a passenger automobile including a two-dimensional barcode etched into the windshield and the passenger-side front and rear side glass windows;

FIG. 2 is a side view of the automobile of FIG. 1 illustrating the two-dimensional bar code etched into the driver-side front and rear side glass windows;

FIG. 3 is a rear perspective view of the automobile of FIG. 1 illustrating the two-dimensional barcode etched into the rear windshield; and

FIG. 4 is a flow chart illustrating an exemplary method of accessing vehicle-specific information from glass surfaces of the vehicle.

### DETAILED DESCRIPTION

The present disclosure may be understood more readily by reference to the following detailed description of the disclosure taken in connection with the accompanying drawing figures, which form a part of this disclosure. It is to be understood that this disclosure is not limited to the specific devices, methods, conditions or parameters described and/or shown herein, and that the terminology used herein is for the purpose of describing particular embodiments by way of example only and is not intended to be limiting of the claimed disclosure. Also, as used in the specification and including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment. It is also understood that all spatial references, such as, for example, horizontal, vertical, top, upper, lower, bottom, left and right, are for illustrative purposes only and can be varied within the scope of the disclosure. For example, the references “upper” and “lower” are relative and used only in the context to the other, and are not necessarily “superior” and “inferior”.

Some electric vehicles have one battery and others may have multiple batteries in a variety of locations of the vehicle, such as, for example, under the hood, in the truck, and/or under the seats. It is imperative that the vehicle owner/operator or a technician or service provider repairing or otherwise working on an electric vehicle know where the batteries are located in the vehicle so that the battery or batteries can be disconnected before operating on the vehicle to avoid electric shock. It is nearly impossible for an owner, technician, or service provider to have a working knowledge of the exact locations of the batteries electric systems for every electric vehicle.

In addition, since air bags deploy at approximately 200 mph, it is important for the technician/service provider to know where the air bags and air bag detonator are located, and where the batteries are located so that disarming of the air bag is performed properly. Access to this information may be needed after dealers are closed.

When the vehicle owner, operator, or service provider jacks or lifts up an electric vehicle, for example, to change a flat tire, it is important to use the stabilization (lift) points to connect to the structural part of the vehicle to avoid crushing a non-structural part of the vehicle and to avoid crushing high voltage cables. Further, knowing the appropriate tire pressure is important because low tire pressure leads to more of the tire's surface area touching the ground, and thus more friction between the tire and the road. More friction means more wear, more heat, more often, all of which put tires at risk for tread separation, a tire blowout, and a serious accident. High tire pressure, on the other hand, leads to less of the tire's surface area touching the ground, which will decrease the vehicle intended stopping distance for this particular vehicle. Whether under or overinflated, improper tire pressure can lead to uneven and premature tire wear. Properly inflated tires typically last much longer than improperly inflated ones.

Each vehicle within the same classification may have different required tire pressure, which is why tire pressure labels are often found on the left front door. However, vehicles are often missing these labels because the vehicle may have been in an accident and labels were never replaced, the labels were available from the manufacture, after time the glue dries and the label falls off during washing vehicle, time fades the labels, damage to the label from the seat belt scraping off the tire pressure, or the door was replaced with a used door when repaired.

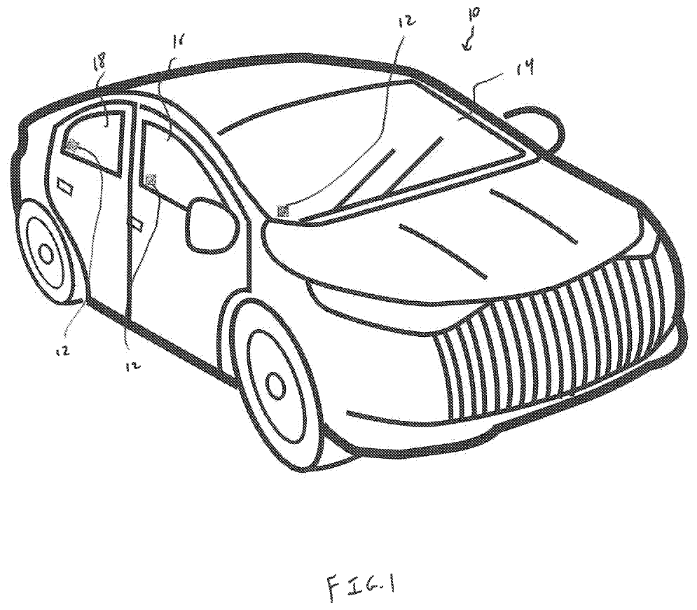

With reference to FIGS. 1-3, a passenger automobile, such as, for example, an electric vehicle 10 is illustrated having a barcode 12 etched into various glass surfaces of the automobile 10. While the present disclosure focuses on a passenger electric vehicle, it is contemplated that the methods described herein may be used with any suitable type of vehicle, such as a gasoline or diesel vehicles. The barcode 12 is a two-dimensional barcode (e.g., a quick response (QR) barcode) that stores or encodes various information about the automobile 10. In aspects, the barcode 12 may be any suitable type of barcode, such as a one-dimensional, two-dimensional, or three-dimensional barcode including a QR code, a data matrix code, a PDF417 code, or a snap tag. In other aspects, the vehicle glass may have thereon or therein other suitable types of machine-readable markings such as an RFID tag.

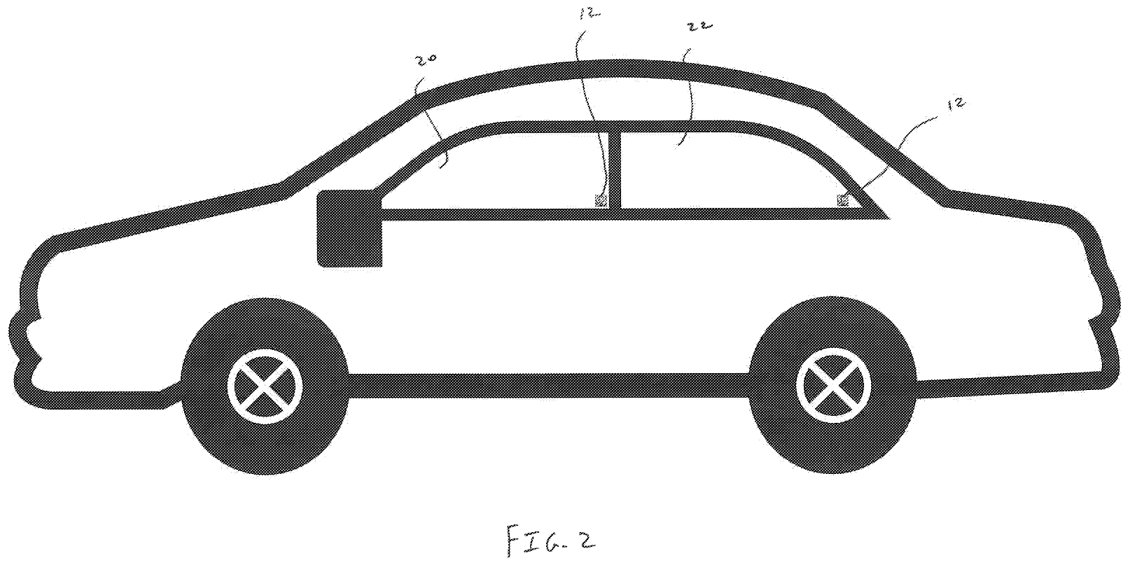

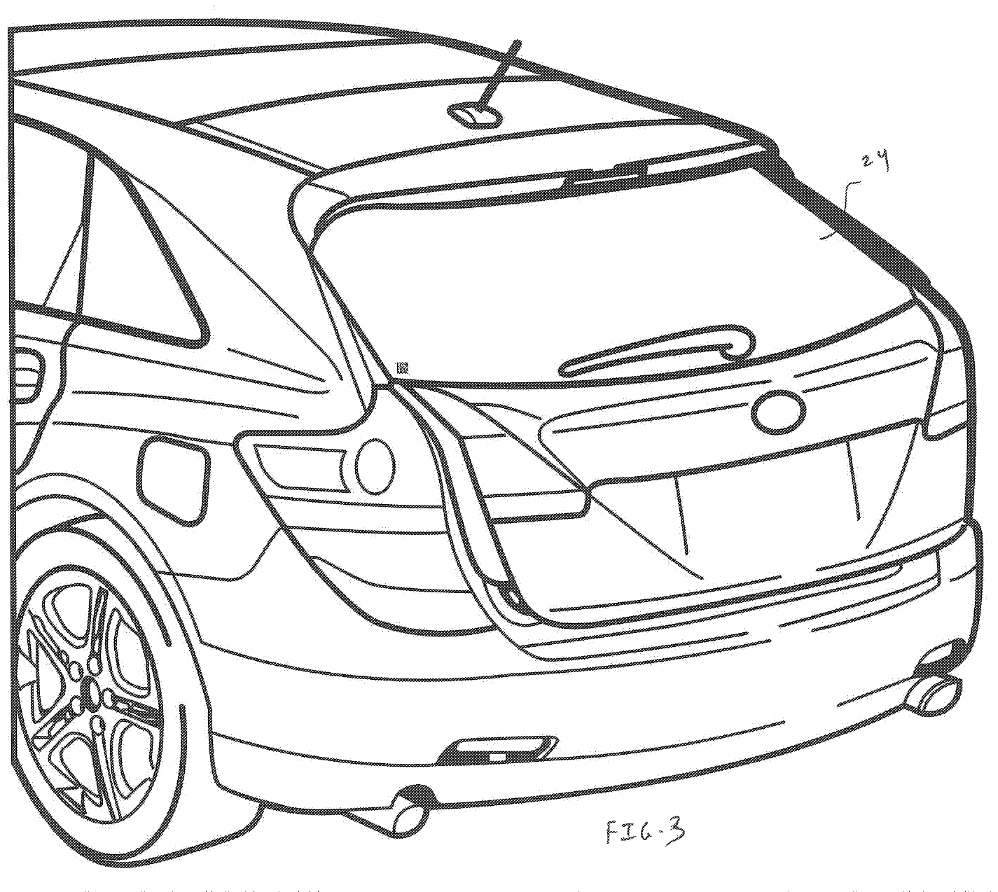

As illustrated in FIGS. 1-3, the barcode 12 is permanently marked onto or into the windshield 14, the passenger-side front and rear side windows 16, 18 (FIG. 1), the driver-side front and rear side windows 20, 22 (FIG. 2), and/or the rear windshield 24 (FIG. 3). In aspects, the barcode 12 may be marked into or onto any or all of the glass surfaces of the automobile 10. In aspects, the same barcode 12 or a different barcode 12 is marked into or onto each of the glass surfaces of the automobile 12. In aspects, the barcode 12 is permanently marked on the glass using any suitable type of marking, such as, for example, etching, engraving, inks, laser marking, or the like. In aspects, an opaque surface may be provided on the glass surface behind the barcode to assist a scanner in reading the barcode. In aspects, the opaque surface may be a white or lightly colored background applied to the glass surface first, and the barcode is then marked onto or into the background. In other aspects, the opaque surface may be a white or lightly colored background printed over the barcode and onto the glass surface after the barcode is marked or printed onto the glass surface.

The barcode 12 has stored therein safety and repair information about the particular automobile 10. The information stored in the barcode 12 may be, for example, the location of critical structures within the automobile 10, such as, for example, the location and/or type of batteries (e.g., lithium-ion, nickel-metal hydride, lead-acid, and ultracapacitors). Other information about the automobile 10 stored in the barcode 12 may include the vehicle make, model, year, fuel type, tire size, rim size, towing instructions, spare tire information, regular and maximum tire pressure, jacking instructions, etc.

For safety purposes, a person working on the vehicle may need to be aware of some this information. For example, batteries need to be disconnected when working on a vehicle. Further, if a technician or other person does not know that there are multiple batteries, injury or death could occur. High voltage lines must be located prior to jacking or towing a vehicle.

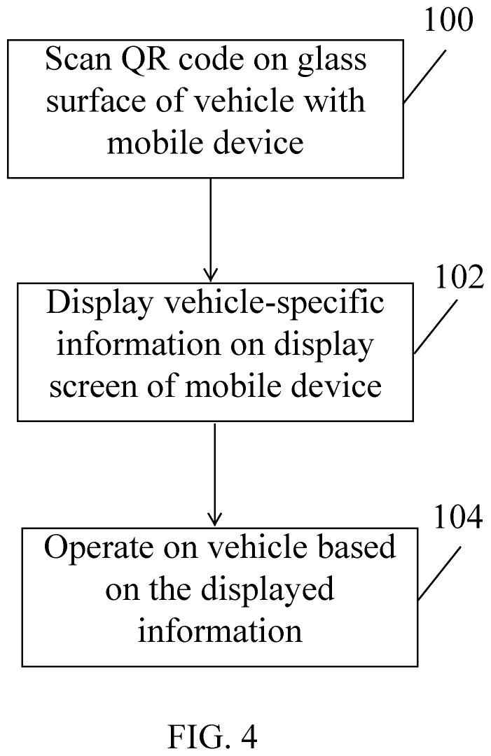

With reference to FIG. 4, an exemplary method of storing, accessing, and displaying safety and repair information about an electric vehicle. The safety information is encoded in the barcode 12, which is marked into or onto the glass of the vehicle 10. In step 100, a user may scan the barcode 12 with a hand-held barcode scanner (not explicitly shown), such as, for example, a smartphone, a tablet, smart watch, etc., whereby the scanner decodes the information stored in the barcode 12. In aspects, the user may open the mobile application on their mobile device before scanning the barcode 12. In step 102, depending on the information stored in the barcode 12, the barcode scanner may then display the vehicle information encoded on the barcode 12 on a display screen provided on the barcode scanner (e.g., the display screen of a smartphone) in text that is readable by the user. In other aspects, the barcode scanner may access and display a website or the mobile application that has the vehicle information and is accessible by the user. In step 104, the user may then operate on the vehicle based on the information displayed, for example, to avoid any batteries shown on the display.

In aspects, the information displayed on the mobile application may be an image of the vehicle shown in phantom or color and the relative locations of the batteries, jacking locations, air bag locations, etc. shown in solid lines. Alternatively or in addition, the information displayed may include textual instructions for how to disconnect or charge a battery and/or a textual description of the specific location of a critical structure (e.g., the battery is under the driver-side seat, in the trunk, or under the hood).

It will be understood that various modifications may be made to the methods disclosed herein. Therefore, the above description should not be construed as limiting, but merely as exemplification of the various embodiments. Those skilled in the art will envision other modifications within the scope and spirit of the claims appended hereto.

What is claimed is:

1. A method of encoding, accessing, and displaying information about an automobile, comprising:
marking a barcode into or onto at least one glass surface of an automobile, the barcode encoding safety information about the automobile;
scanning the barcode; and
displaying the information about the automobile.

2. The method according to claim 1, wherein marking the barcode includes etching the barcode into the at least one glass surface.

3. The method according to claim 1, wherein the barcode is a quick response (QR) code.

4. The method according to claim 1, wherein the at least one glass surface is at least one of a front windshield, rear windshield, passenger-side window, or driver-side window of the automobile.

5. The method according to claim 1, wherein the automobile is an electric vehicle.

6. The method according to claim 5, wherein the information about the electric vehicle includes a location of a battery, towing instructions, or a jacking location.

7. The method according to claim 6, further comprising operating on the electric vehicle based on the location of the battery or the jacking location.

8. The method according to claim 1, wherein the barcode is a two-dimensional barcode or a three-dimensional barcode.

9. The method according to claim 8, wherein the barcode is a snap tag.

10. A method of encoding, accessing, and displaying information about an electric vehicle, comprising:
marking a quick response (QR) code into or onto at least one glass surface of the electric vehicle, the QR code encoding information about the electric vehicle, the information including at least one of a jacking location, towing instructions, tire pressure, a location of an air bag, or a location of a battery;
accessing a mobile application on a mobile device;
scanning the barcode with the mobile device; and
displaying the information about the electric vehicle on the mobile application.

11. The method according to claim 10, further comprising operating on the electric vehicle based on the information about the electric vehicle.

12. The method according to claim 10, wherein the at least one glass surface is at least one of a front windshield, rear windshield, passenger-side window, or driver-side window of the electric vehicle.

13. The method according to claim 10, further comprising applying an opaque background on the at least one glass surface prior to marking the QR code into or onto the at least one glass surface.
